(19) United States
(12) Patent Application Publication
(10) Pub. No.: US 2018/0176921 A1
(43) Pub. Date: Jun. 21, 2018

(54) REPORT FOR INTER-BSS INTERFERENCE AVOIDANCE

(71) Applicant: INTEL IP CORPORATION, SANTA CLARA, CA (US)

(72) Inventors: Laurent CARIOU, Portland, OR (US); Robert STACEY, Portland, OR (US)

(21) Appl. No.: 15/384,934

(22) Filed: Dec. 20, 2016

(51) Int. Cl. H04W 72/08; H04W 72/04; H04W 24/10

(52) U.S. Cl. CPC H04W 72/082; H04W 72/0446; H04W 84/12; H04W 72/085; H04W 24/10

(57) ABSTRACT

In dense environments, OBSSs can still be very close to each other. Spatial reuse attempts to tune sensitivity levels and transmit power in devices to isolate as much as possible the different OBSSs, so that OBSSs do not share the medium in time, but rather reuse the medium, which is a great addition from IEEE 802.11ax. Interference can however still happen, especially at the edge of BSSs where, for example, there are hidden node(s). Spatial reuse might even increase this interference in this scenario. Instead of forcing protection with RTS/CTS every time on the edge of BSSs, which can have a negative impact on the spatial reuse and on area throughput, inter-BSS interference avoidance solutions can be applied.

### TECHNICAL FIELD

An exemplary aspect is directed toward communications systems. More specifically an exemplary aspect is directed toward wireless communications systems and even more specifically to interference management in wireless networks. Even more particularly, an exemplary aspect is directed toward resource allocation for interference reduction.

### BACKGROUND

Wireless networks are ubiquitous and are commonplace indoors and outdoors and in shared locations. Wireless networks transmit and receive information utilizing varying techniques and protocols. For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary operational environment in a deployment with frequency reuse;

FIG. 2 illustrates an exemplary interference example;

FIG. 3 illustrates another exemplary interference example;

FIG. 4 illustrates an example of a neighbour STA interference report element;

FIG. 5 illustrates an exemplary interference avoidance or reduction example;

FIGS. 6-7 illustrate exemplary time-based interference avoidance or reduction techniques;

FIG. 8 illustrates an exemplary wireless device and associated componentry usable with the techniques disclosed herein; and

FIG. 9 is a flowchart illustrating an exemplary method for reducing interference between one or more devices.

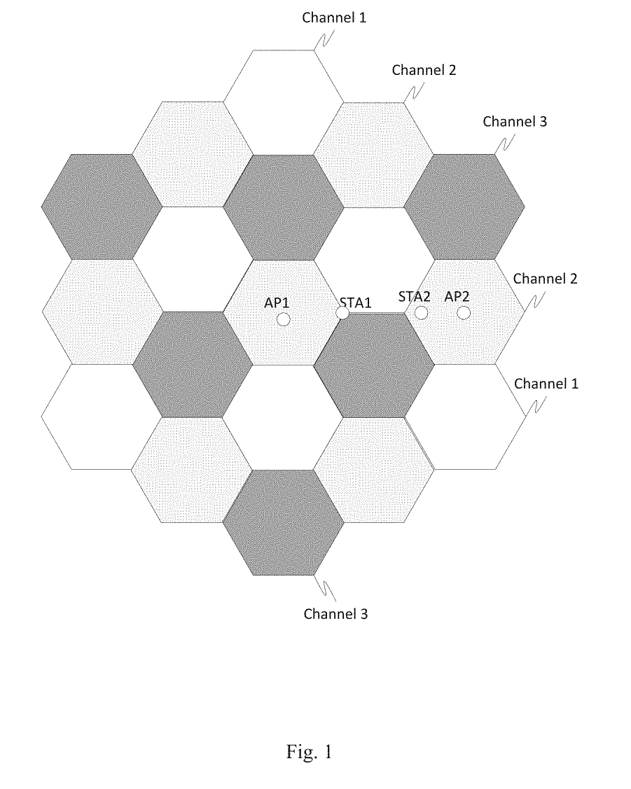

### DESCRIPTION OF EMBODIMENTS

Wi-Fi is being deployed in managed environments more frequently. In such environments, the APs (Access Points) are often managed by a controller, and a specific frequency reuse pattern is applied in order to reduce interference between neighbouring BSSs (Basis Service Sets). A basic service set provides the fundamental building-block of an IEEE 802.11 wireless LAN. In infrastructure mode, a single access point (AP) together with all associated stations (STAs) is called a BSS. The basic service set (BSS) is a set of all stations that can communicate with each other at PHY (physical layer of the OSI model). Every BSS has an identification (ID) called the BSSID, which is the MAC address of the access point servicing the BSS. There are two types of BSS: Independent BSSs (also referred to as IBSS), and infrastructure BSS. An independent BSS (IBSS) is an ad hoc network that contains no access points, which means they cannot connect to any other basic service set. An extended service set (ESS) is a set of connected BSSs. Access points in an ESS are connected by a distribution system. Each ESS has an ID called the SSID which is, for example, a 32-byte character string.

In spite of the specific frequency reuse pattern, in dense environments, OBSSs (overlapping BSS) can still be very close to each other. Spatial reuse attempts to tune sensitivity levels and transmit power to isolate as effectively as possible the different OBSSs such that OBSSs do not share the medium in time, but rather reuse the medium, which is a great improvement to at least IEEE 802.11ax.

Interference can still however happen, especially at the edge(s) of BSSs where, for example, there is a hidden node situation with OBSSs. Spatial reuse in this environment may even increase this interference.

Instead of forcing protection with RTS/CTS (Request to Send/Clear To Send) every time on the edge, which can have a negative impact on spatial reuse and on area throughput, inter-BSS interference avoidance solutions can be applied.

In accordance with one exemplary embodiment, a technique is presented that identifies STAs (Stations) belonging to different OBSSs that interfere with each other, and to allocate to the stations orthogonal resources, in order to avoid interference. This can be referred to as inter-BSS interference avoidance.

As IEEE 802.11ax supports UL (uplink) and DL (downlink) OFDMA (Orthogonal Frequency-Division Multiple Access), an example of such inter-BSS interference avoidance is to have coordination between 2 BSSs so that different RU (Resource Unit) allocations are used for, for example, two close STAs belonging to the 2 different BSSs. In OFDMA, and in particular the downlink and uplink physical structure, the radio frame is divided into a number of sub-frames, e.g., eight. Each of the sub-frames can be allocated to uplink or downlink transmissions. Each sub-frame is then divided into a number of frequency partitions and each of these partitions include a plurality of resource units over a number of OFDMA symbols in the sub-frame.

In order to enable such an interference avoidance mechanism, an exemplary embodiment utilizes a standardized or proprietary method of coordination between the APs (Access Points), and/or a standardized way for each AP to identify the STAs from neighbouring BSSs that interfere with each AP's STAs.

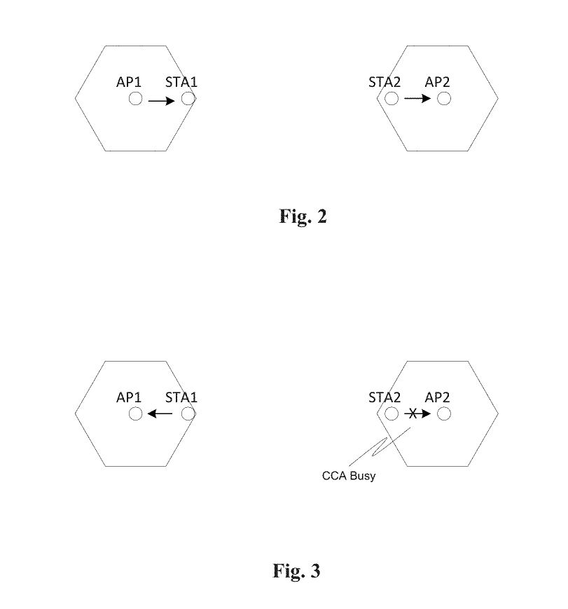

Consider the example shown in FIGS. 2-3. AP1 and AP2 operate on the same channel (Channel 2). STA 1 is associated with AP1, and STA 2 is associated with AP2. STA1 and STA2 are sufficiently close to each other to generate interference.

For example, in FIG. 2, Interference Example 1, AP1 does not see AP2 and STA2. AP1 starts transmitting to STA1. STA2 does not see the AP1 signal above an OBSS_PD and transmits. The STA2 signal creates interference on STA1 causing a detection error for the PPDU (PLCP Protocol Data Unit) from AP1.

In FIG. 3, Interference Example 2, STA1 transmits to AP1. STA2 cannot transmit to AP2 because the STA1 signal triggers a busy CCA (Signal above OBSS-PD)

This interference can either:
Prevent the STAs to simultaneously access the medium, for instance STA2 when transmitting sets the CCA (Clear Channel Assessment) busy at STA1 (case where the STAs see each other above PD (Packet Detection) or OBSS_PD threshold), or
Cause a reception error, for instance STA1 receives from AP1 and gets interfered by STA2 starting transmission to AP2. (This is the case where the STAs see each other between PD and OBSS_PD or got channel access because of, for example, a hidden node situation)

One exemplary embodiment is directed toward a solution where: STAs report to their AP the list of STAs from OBSSs that generate interference (by either setting the CCA busy, or causing interference during reception . . . ), and the level of interference that they receive, and based on this report, the APs from each OBSS communicate and negotiate interference avoidance solutions: for example, they use an orthogonal set of RUs for the interfering STAs.

The neighbour STA interference report. In accordance with one exemplary embodiment, STAs can send the report in an autonomous manner, or as a response to a request from the AP. The system can use as one example a specific “neighbour interference report request frame” and “neighbour interference report response.” The report could contain the list of STAs/APs from neighbouring BSSs that are received by the STA with the highest power. The exemplary report can contain:
The BSSID the interfering STA belongs to
The MAC address (Media Access Control Address) or AID (Association Identity) of the STA
The RSSI (Received Signal Strength Indicator) of received interference
Optionally, the amount of time during which the interference is seen

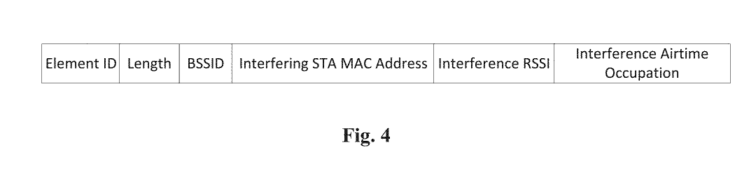

The report response can be designed as a list of Neighbour STA interference report elements, each element corresponding to the report for one particular interfering STA. An example of such element can be seen in FIG. 4. In FIG. 4, the exemplary element can include an Element ID, A length field, a BSSID field, an Interfering STA MAC address field, an interference RSSI and an interference airtime occupation. Of course other fields could be added and the length of each of the illustrative fields can vary.

The exemplary report request can contain different threshold(s) in order to limit the list of neighbour STA that will be reported. The request can optionally contain limits regarding:
The RSSI: one exemplary embodiment only includes in the response the list of neighbour STAs that are received above this RSSI threshold
Specific BSSIDs/ESSIDs (Extended Service Set Identification): one exemplary embodiment only includes in the response the list of neighbour STAs that belong to specific BSSIDs/ESSIDs
STA capabilities: one exemplary embodiment only includes in the response the list of neighbour STAs that are HE capable, as just one example. In general any STA capability could be specified in the response.

The interference avoidance solution. Based on the reports, the two exemplary 2 BSSs can (of course this is extendable to any number of BSSs):
Communicate over the DS (Distribution System) or over the air (in a standardized and/or proprietary way),
Identify STAs from the 2 BSSs that interfere with each other and that are eligible for interference avoidance solutions, and
Negotiate how to apply interference avoidance solutions.

Two exemplary simple solutions are proposed:

The first is to define a limited orthogonal set of RUs for each interfering STA(s), so that the 2 STAs don't interfere with each other (or interfere less) when scheduled at the same instant with UL or DL OFDMA.

Optionally, or in addition, as this solution can solve or reduce interference issues only during UL or DL OFDMA, the APs can agree to restrict EDCA (Enhanced Distributed Channel Access) parameters for those STAs in order to incite those STAs to use UL/DL OFDMA even more.

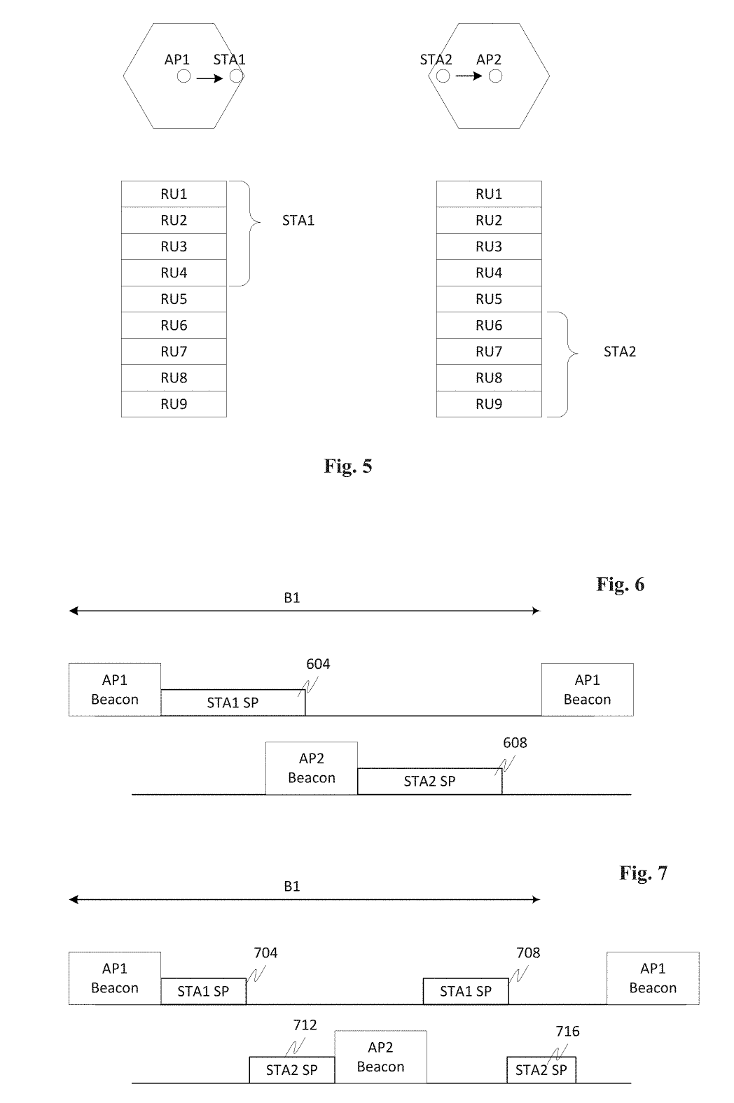

An example of this type of avoidance solution can be seen in FIG. 5. In FIG. 5, RUs 1-4 are allocated to STA 1 and RUs 6-9 are allocated to STA2. With these two sets of RUs being orthogonal to one another, the STAs do not interfere (or interfere less) with one another.

The second exemplary solution defines specific orthogonal periods of time during which each STA can access the medium. For example, each AP can define an agreement with its STA to operate only (or preferably) during specific service periods. These service periods can be defined for instance with the TWT (Target Wake Time) concept or in general defined at any point in time or using any methodology.

For example, FIG. 6 illustrates time-based interference avoidance where STA 1 has a SP (Service Period) 604 and to avoid or reduce the likelihood of interference, STA2 has SPs 608. In FIG. 7 STA 1 has defined SPs 704 and 708 and STA 2 has SPs 712 and 716.

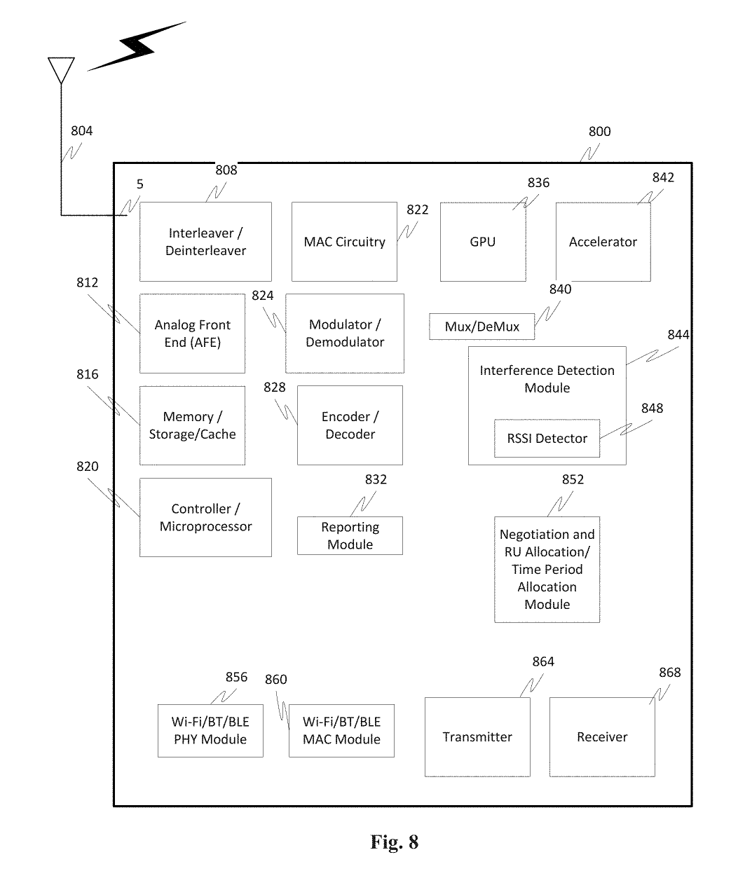

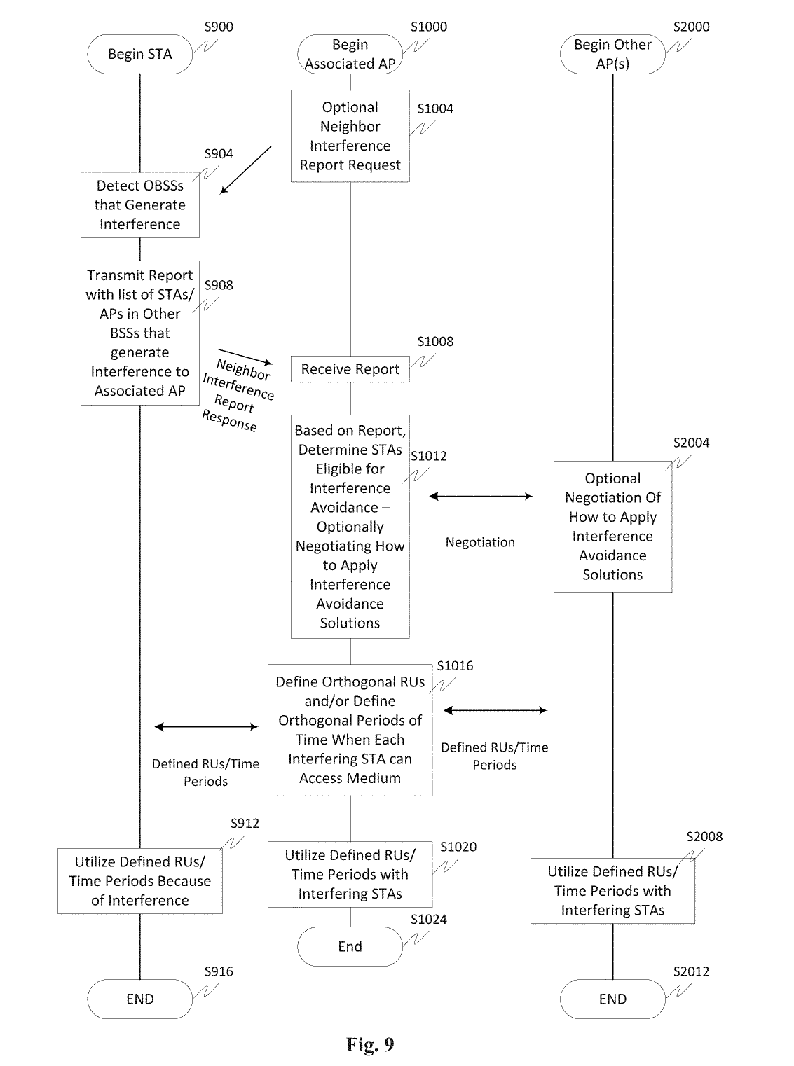

FIG. 8 illustrates an exemplary hardware diagram of a device 800, such as a wireless device, mobile device, access point, station, or the like, that is adapted to implement the technique(s) discussed herein. Operation will be discussed in relation to the components in FIG. 8 appreciating that each separate device, e.g., station, AP, proxy server, etc., can include one or more of the components shown in the figure, with the components each being optional.

In addition to well-known componentry (which has been omitted for clarity), the device 800 includes interconnected elements (with links 5 omitted for clarity) including one or more of: one or more antennas 804, an interleaver/deinterleaver 808, an analog front end (AFE) 812, memory/storage/cache 816, controller/microprocessor 820, MAC circuitry 822, modulator/demodulator 824, encoder/decoder 828, reporting module 832, GPU 836, accelerator 842, a multiplexer/demultiplexer 840, an interference detection module 844, RSSI detector 848, negotiation and RU allocation/time period allocation module 852, and wireless radio components such as a Wi-Fi/BT/BLE PHY module 856, a Wi-Fi/BT/BLE MAC module 860, transmitter 864 and receiver 868. The various elements in the device 800 are connected by one or more links (not shown, again for sake of clarity). The interference detection module 844, RSSI detector, 848 and negotiation and RU Allocation/Time period module 851 can be, for example, software and corresponding processor/memory, an ASIC, a System on a Chip, or in general any hardware, circuit and/or software capable of performing the described functionality. Similarly, the reporting module 832 can be, for example, software and corresponding processor/memory, an ASIC, a System on a Chip, or in general any hardware and/or software capable of performing the described functionality.

The device 800 can have one more antennas 804, for use in wireless communications such as multi-input multi-output (MIMO) communications, multi-user multi-input multi-output (MU-MIMO) communications Bluetooth®, LTE, RFID, 4G, LTE, etc. The antenna(s) 804 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 804 generally interact with the Analog Front End (AFE) 812, which is needed to enable the correct processing of the received modulated signal and signal conditioning for a transmitted signal. The AFE 812 can be functionally located between the antenna and a digital baseband system in order to convert the analog signal into a digital signal for processing and vice-versa.

The device 800 can also include a controller/microprocessor 820 and a memory/storage/cache 816. The device 800 can interact with the memory/storage/cache 816 which may store information and operations necessary for configuring and transmitting or receiving the information described herein. The memory/storage/cache 816 may also be used in connection with the execution of application programming or instructions by the controller/microprocessor 820, and for temporary or long term storage of program instructions and/or data. As examples, the memory/storage/cache 820 may comprise a computer-readable device, RAM, ROM, DRAM, SDRAM, and/or other storage device(s) and media.

The controller/microprocessor 820 may comprise a general purpose programmable processor or controller for executing application programming or instructions related to the device 800. Furthermore, the controller/microprocessor 820 can perform operations for configuring and transmitting information as described herein. The controller/microprocessor 820 may include multiple processor cores, and/or implement multiple virtual processors. Optionally, the controller/microprocessor 820 may include multiple physical processors. By way of example, the controller/microprocessor 820 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 800 can further include a transmitter 864 and receiver 868 which can transmit and receive signals, respectively, to and from other wireless devices and/or access points using the one or more antennas 804. Included in the device 800 circuitry is the medium access control or MAC Circuitry 822. MAC circuitry 822 provides for controlling access to the wireless medium. In an exemplary embodiment, the MAC circuitry 822 may be arranged to contend for the wireless medium and configure frames or packets for communicating over the wireless medium.

The PHY Module/Circuitry 856 controls the electrical and physical specifications for device 800. In particular, PHY Module/Circuitry 856 manages the relationship between the device 800 and a transmission medium. Primary functions and services performed by the physical layer, and in particular the PHY Module/Circuitry 856, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 856 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 122 handle coordination of interactions between the MAC and PHY layers.

The interleaver/deinterleaver 808 cooperates with the various PHY components to provide Forward Error correction capabilities. The modulator/demodulator 824 similarly cooperates with the various PHY components to perform modulation which in general is a process of varying one or more properties of a periodic waveform, referred to and known as a carrier signal, with a modulating signal that typically contains information for transmission. The encoder/decoder 828 manages the encoding/decoding used with the various transmission and reception elements in device 800.

The MAC layer and components, and in particular the MAC module 860 and MAC circuitry 822 provide functional and procedural means to transfer data between network entities and to detect and possibly correct errors that may occur in the physical layer. The MAC module 860 and MAC circuitry 822 also provide access to contention-based and contention-free traffic on different types of physical layers, such as when multiple communications technologies are incorporated into the device 800. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 800 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 842 can cooperate with MAC circuitry 822 to, for example, perform real-time MAC functions. The GPU 836 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In operation, and either automatically or optionally based on a neighbour interference report request from an AP, a STA using, for example, the interference detection module 844 (optionally with the RSSI detector 848 or other circuit/device/technique for interference detection) detects OBSSs that generate interference.

With the interference information, the STA assembles, with the cooperation of the reporting module 832, and transmits, with the cooperation of the processor 820, memory 816 and transmitter 864, a report including a list or other identification of the STA(s)/AP(s) in other BBSs that generate interference. This report is sent to the AP that the STA is associated with.

Upon receipt of the report by the AP, the AP determines one or more STAs eligible for interference avoidance. This determination is performed with the negotiation and RU allocation/time period allocation module 852, and optionally negotiated with the AP(s) with which this is an interference issue. As discussed, this negotiation between the various APs can occur over a DS or other proprietary or non-proprietary communication technique.

Based on the result of the determination and/or negotiation, the negotiation and RU allocation/time period allocation module 852 defines orthogonal RUs and/or orthogonal periods of time when each STA can access the medium thereby reducing interference. As discussed, the defining of orthogonal RU's can be supplemented with the restriction of EDCA parameters as discussed.

The various negotiation and RU allocation/time period allocation modules in the various interfering devices then utilize the defined RUs/time periods for subsequent communications.

FIG. 10 outlines an exemplary technique for reducing interference. Control begins in step S900 for a STA, in step S1000 for the associated AP, and ion step S2000 for another AP.

For the STA, and in step S904, either automatically or in response to a neighbour interference report request (step S1004), the STA detects OBSSs that generate interference. As discussed, this interference detection can be performed using any know or developed technique for interference detection. While an exemplary embodiment is discussed in relation to using RSSI, the techniques discussed herein are not limited thereto. The generated report in step S908 is then transmitted to the AP which receives the report in step S1008. With the report, the AP in step S1012 determines one or more STAs eligible for interference avoidance. This determination can be optionally negotiated with the other AP(s) with which there is an interference issue (See step S2004). As discussed, this negotiation between the various APs can occur over a DS or other channel and/or using some other proprietary or non-proprietary communication technique.

Based on the result of the determination and/or negotiation, in step S1016 the Ap defines orthogonal RUs and/or orthogonal periods of time when each STA can access the medium thereby reducing interference. As discussed, the defining of orthogonal RU's can be supplemented with the restriction of EDCA parameters.

The various negotiation and RU allocation/time period allocation modules in the various interfering devices then utilize the defined RUs/time periods for subsequent communications (See step S912/S1020/S2008). Control then continues for each respective device to an end.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:
A wireless communications device comprising:
   a processor in communication with a receiver to receive an interference report;
a negotiation and RU allocation/time period allocation module in communication with the processor to determine one or more stations eligible for interference reduction and one or more of: define orthogonal resource units and/or define orthogonal periods of time for each of the stations eligible for interference reduction.
Any of the above aspects, wherein the interference report includes an identification of stations, access points and/or Basic Service Sets that are generating interference.
Any of the above aspects, wherein a received signal strength indicator determines the interference.
Any of the above aspects, wherein the orthogonal resource units are a limited set with reduced interference.
Any of the above aspects, wherein the interference reduction further includes restricted Enhanced Distributed Channel Access parameters.
Any of the above aspects, wherein the orthogonal periods of time are service periods.
Any of the above aspects, wherein the service periods are based on a target wake time.
Any of the above aspects, further comprising the processor and transmitter forwarding a report request to a station requesting identification of interfering devices, the report request including at least one limit regarding interfering devices.
Any of the above aspects, configured to one or more of reduce interference and improve connectivity between one or more wireless devices.
Any of the above aspects, wherein the device is an access point.
A non-transitory information storage media having stored thereon one or more instructions, that when executed by one or more processors, cause a clusterable wireless device to perform a method comprising:
receiving an interference report;
determining one or more stations eligible for interference reduction and one or more of:
defining orthogonal resource units and/or defining orthogonal periods of time for each of the stations eligible for interference reduction.
Any of the above aspects, wherein the interference report includes an identification of stations, access points and/or Basic Service Sets that are generating interference.
Any of the above aspects, wherein a received signal strength indicator determines the interference.
Any of the above aspects, wherein the orthogonal resource units are a limited set with reduced interference.
Any of the above aspects, wherein the interference reduction further includes restricted Enhanced Distributed Channel Access parameters.
Any of the above aspects, wherein the orthogonal periods of time are service periods.
Any of the above aspects, wherein the service periods are based on a target wake time.
Any of the above aspects, further comprising forwarding a report request to a station requesting identification of interfering devices, the report request including at least one limit regarding interfering devices.
A wireless communications device comprising:
means for receiving an interference report;
means for determining one or more stations eligible for interference reduction and one or more of: defining orthogonal resource units and/or defining orthogonal periods of time for each of the stations eligible for interference reduction.
Any of the above aspects, wherein the orthogonal periods of time are service periods and the service periods are based on a target wake time.
Any of the above aspects, wherein the interference report includes an identification of stations, access points and/or Basic Service Sets that are generating interference.
Any of the above aspects, wherein a received signal strength indicator determines the interference.
Any of the above aspects, wherein the orthogonal resource units are a limited set with reduced interference.
Any of the above aspects, wherein the interference reduction further includes restricted Enhanced Distributed Channel Access parameters.
Any of the above aspects, wherein the orthogonal periods of time are service periods.
Any of the above aspects, further comprising the processor and transmitter forwarding a report request to a station requesting identification of interfering devices, the report request including at least one limit regarding interfering devices.
Any of the above aspects, configured to one or more of reduce interference and improve connectivity between one or more wireless devices.
A wireless communications device comprising:
   a processor in communication with a transmitter to transmit an interference report;
a receiver to receive one or more defined Resource Units (RUs) and/or Time periods for communication wherein the one or more defined Resource Units (RUs) and/or Time periods where defined as orthogonal resource units and/or orthogonal periods of time for each stations eligible for an interference reduction.
Any of the above aspects, wherein the interference report includes an identification of stations, access points and/or Basic Service Sets that are generating interference.
Any of the above aspects, wherein a received signal strength indicator determines the interference.
Any of the above aspects, wherein the orthogonal resource units are a limited set with reduced interference.
Any of the above aspects, wherein the interference reduction further includes restricted Enhanced Distributed Channel Access parameters.
Any of the above aspects, wherein the orthogonal periods of time are service periods.
Any of the above aspects, wherein the service periods are based on a target wake time.
Any of the above aspects, further comprising the processor and receiver receiving a report request requesting identification of interfering devices, the report request including at least one limit regarding interfering devices.
Any of the above aspects, configured to one or more of reduce interference and improve connectivity between one or more wireless devices.
Any of the above aspects, wherein the device is a station.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a processor in communication with a receiver to receive an interference report;
a negotiation and RU allocation/time period allocation module in communication with the processor to determine one or more stations eligible for interference reduction and one or more of: define orthogonal resource units and/or define orthogonal periods of time for each of the stations eligible for interference reduction.

2. The device of claim 1, wherein the interference report includes an identification of stations, access points and/or Basic Service Sets that are generating interference.

3. The device of claim 2, wherein a received signal strength indicator determines the interference.

4. The device of claim 1, wherein the orthogonal resource units are a limited set with reduced interference.

5. The device of claim 4, wherein the interference reduction further includes restricted Enhanced Distributed Channel Access parameters.

6. The device of claim 1, wherein the orthogonal periods of time are service periods.

7. The device of claim 6, wherein the service periods are based on a target wake time.

8. The device of claim 1, further comprising the processor and transmitter forwarding a report request to a station requesting identification of interfering devices, the report request including at least one limit regarding interfering devices.

9. The device of claim 1, configured to one or more of reduce interference and improve connectivity between one or more wireless devices.

10. The device of claim 1, wherein the device is an access point.

11. A non-transitory information storage media having stored thereon one or more instructions, that when executed by one or more processors, cause a clusterable wireless device to perform a method comprising:
receiving an interference report;
determining one or more stations eligible for interference reduction and one or more of: defining orthogonal resource units and/or defining orthogonal periods of time for each of the stations eligible for interference reduction.

12. The media of claim 11, wherein the interference report includes an identification of stations, access points and/or Basic Service Sets that are generating interference.

13. The media of claim 12, wherein a received signal strength indicator determines the interference.

14. The media of claim 11, wherein the orthogonal resource units are a limited set with reduced interference.

15. The media of claim 14, wherein the interference reduction further includes restricted Enhanced Distributed Channel Access parameters.

16. The media of claim 11, wherein the orthogonal periods of time are service periods.

17. The media of claim 16, wherein the service periods are based on a target wake time.

18. The media of claim 11, further comprising forwarding a report request to a station requesting identification of interfering devices, the report request including at least one limit regarding interfering devices.

19. A wireless communications device comprising:
means for receiving an interference report;
means for determining one or more stations eligible for interference reduction and one or more of: defining orthogonal resource units and/or defining orthogonal periods of time for each of the stations eligible for interference reduction.

20. The device of claim 19, wherein the orthogonal periods of time are service periods and the service periods are based on a target wake time.
